(19) United States
(12) Patent Application Publication
(10) Pub. No.: US 2013/0222886 A1
(43) Pub. Date: Aug. 29, 2013

(54) DISPERSION LIQUID FOR DISPLAY, DISPLAY MEDIUM, AND DISPLAY DEVICE

(71) Applicants: FUJI XEROX CO., LTD., (US); FUJIFILM Corporation, (US)

(72) Inventors: Jun KAWAHARA, Minamiashigara-shi (JP); Hiroshi KAYASHIMA, Minamiashigara-shi (JP); Shigeaki OHTANI, Kanagawa (JP); Yoshio TADAKUMA, Kanagawa (JP)

(73) Assignees: FUJIFILM CORPORATION, Tokyo (JP); FUJI XEROX CO., LTD., Tokyo (JP)

(21) Appl. No.: 13/718,754

(22) Filed: Dec. 18, 2012

(30) Foreign Application Priority Data
Feb. 27, 2012 (JP) 2012-040623

(51) Int. Cl. G02F 1/167; C08L 43/04

(52) U.S. Cl. CPC G02F 1/167; C08L 43/04
USPC 359/296; 524/521

(57) ABSTRACT

A dispersion liquid for display including: a dispersion medium; and floating particles which are dispersed and float in the dispersion medium, wherein the floating particles containing: core particles including a colorant and a hydrophilic resin; and a shell covering a surface of each of the core particles and containing a hydrophobic resin with a difference in a solubility parameter of 7.95 (J/cm³)^{1/2} or more, the solubility parameter which is represented as SP value with respect to the dispersion medium.

### CROSS-REFERENCE TO RELATED APPLICATION(S)

This application is based on and claims priority under 35 U.S.C. 119 from Japanese Patent Application No. 2012-040623 filed on Feb. 27, 2012.

### BACKGROUND

1. Technical Field

The present invention relates to a dispersion liquid for display, a display medium, and a display device.

2. Related Art

In the past, a display technique using electrophoresis has been proposed as a display medium that is repeatedly rewritable.

As such a display technique, a composite particle in which white or colored particles are covered by a resin and in which the white or colored particles can be dispersed in a dispersion medium using a dispersing agent, the resin is a polymer generated by a reaction between a reactive group within the dispersing agent molecules adsorbed onto the white or colored particles and at least one type of monomer, and which is not dissolved in the dispersion medium, is disclosed in JP-A-2008-122468, for example.

Further, in an electrophoretic ink composition in which charged particles within a dispersion medium react and migrate by applying an electric field, using a non-protic solvent as the dispersion medium, being configured mainly by a pigment, a resin compound, and a charge adjust agent with a solubility of 5% by mass or less with respect to the non-protic solvent, and when preparing the ink composition, dispersing the pigment, the resin compound, and the charge adjust agent in a good solvent in which the resin compound and the charge adjust agent can be dissolved, and by mixing the obtained dispersion liquid and the non-protic solvent in which the resin compound and the charge adjust agent are not easily dissolved, a method for forming charged particles formed to include the pigment, the resin compound, and the charge adjust agent through coacervation, is disclosed in JP-A-2004-279732.

Further, in JP-A-2005-255910 is disclosed a method in which dispersion polymerization is performed using an organic solvent A which is a non-polar solvent and an organic solvent B which is a non-polar solvent with a lower boiling temperature than organic solvent A with hardly any compatibility with the organic solvent A, and a preparing method for a polymer particle dispersant in which a polymerizable monomer that dissolves in the organic solvent B and that does not dissolve in the organic solvent A is added to the organic solvent B as a reaction compatible liquid, the reaction compatible liquid is dispersed in the organic solvent A to form a dispersion liquid having a dispersed phase of the reaction compatible liquid and a continuous phase of the organic solvent A, the monomer that can be polymerized in the dispersed phase is polymerized, and the organic solvent B is removed from the dispersion liquid through decompression or heating.

Further, in Patent JP-A-2009-053556 is disclosed a capsulized particle manucacturing device including at least two fluid introduction ports, a first flow path connected so that one end is connected to each fluid introduction portion and the other end joins each fluid introduction port and including a bent portion to the downstream, a second flow path extending from the bent portion of the first flow path in a tangential direction thereof, and a fluid discharge port connected to the second flow path, and on which a pair of opposing electrodes are provided on a flow path at a branching portion of the first flow path and the second flow path.

Further, in JP-A-2009-061436 is disclosed a capsulized particle manufacturing device manufacturing capsulized particles through a coacervation method by mixing a dispersion liquid in which particles covered by a covering material are dispersed in a solvent in which at least the covering material is dissolved and a poor solvent compatible with the solvent described above and including a solvent in which the covering material is not dissolved, that is, a method of manufacturing capsulized particles through a coacervation method.

Further, in JP-A-2008-051931 is disclosed a method in which white charged particles and black charged particles dispersed in a display liquid have a form in which a plurality of hydrophobic child particles are joined on the surface of hydrophilic mother particles, and the coverage ratio of the child particles with respect to the surface area of the mother particles is within a range from 18% to 35%.

An object of the present application is to provide a dispersion liquid for display in which the movement of floating particles with respect to an electric field is suppressed.

### SUMMARY

<1> A dispersion liquid for display including: a dispersion medium; and floating particles which are dispersed and float in the dispersion medium, wherein the floating particles containing: core particles including a colorant and a hydrophilic resin; and a shell covering a surface of each of the core particles and containing a hydrophobic resin with a difference in a solubility parameter of 7.95 (J/cm³)^{1/2} or more, the solubility parameter which is represented as SP value with respect to the dispersion medium.

### BRIEF DESCRIPTION OF THE DRAWINGS

Exemplary embodiments of the present invention will be described in detail based on the following figures, wherein:

FIG. 1 is an outline configuration view illustrating an outline of a configuration of floating particles in the exemplary embodiment;

FIG. 2 is an outline view for describing the behavior of the phoretic particles in a display medium including a dispersion liquid for display according to the exemplary embodiment containing one type of phoretic particles;

FIG. 3 is an outline view for describing the behavior of the phoretic particles in a display medium including a dispersion liquid for display according to the exemplary embodiment containing one type of phoretic particles;

FIG. 4 is an outline view for describing the behavior of the phoretic particles in a display medium including a dispersion liquid for display according to the exemplary embodiment containing one type of phoretic particles;

FIG. 5 is an outline view for describing the behavior of the phoretic particles in a display medium including a dispersion liquid for display according to the exemplary embodiment containing one type of phoretic particles;

FIG. 6 is a graph illustrating the relationship between the applied voltage (rectangular wave) and the charge amount in the states of FIGS. 2 to 5;

FIG. 7 is an outline view for describing the behavior of the phoretic particles in a display medium including a dispersion liquid for display according to the exemplary embodiment containing two types of phoretic particles;

FIG. 8 is an outline view for describing the behavior of the phoretic particles in a display medium including a dispersion liquid for display according to the exemplary embodiment containing two types of phoretic particles;

FIG. 9 is an outline view for describing the behavior of the phoretic particles in a display medium including a dispersion liquid for display according to the exemplary embodiment containing two types of phoretic particles; and

FIG. 10 is an outline view for describing the behavior of the phoretic particles in a display medium including a dispersion liquid for display according to the exemplary embodiment containing two types of phoretic particles.

### DETAIED DESCRIPTION

Exemplary embodiments of the present invention will be described below.

### <Dispersion Liquid for Display>

The dispersion liquid for display according to the exemplary embodiment includes a dispersion medium; and floating particles which are dispersed and float in the dispersion medium, wherein the floating particles containing: core particles including a colorant and a hydrophilic resin; and a shell covering a surface of each of the core particles and containing a hydrophobic resin with a difference in a solubility parameter of 7.95 (J/cm³)^{1/2} or more, the solubility parameter which is represented as SP value with respect to the dispersion medium.

The dispersion liquid for display according to the exemplary embodiment includes a dispersion medium (insulating fluid) such as silicone oil and floating particles that are dispersed and float in the dispersion medium, and may also include phoretic particles that migrate and move according to an electric field. The phoretic particles have charging characteristics in a state of being dispersed in the dispersion medium, and migrate and move within the dispersion medium according to the formed electric field.

Here, the floating particles are particles dispersed in the dispersion medium with the purpose of displaying the background color or the like when applied as the display medium or the like, and unlike the phoretic particles, it is necessary for phoresis to be suppressed even when an electric field is formed, that is, it is necessary for the degree of movement with respect to an electric field be lower than for the phoretic particles.

However, if a colorant such as a white pigment (for example, titanium oxide) is contained in the floating particles, since the charge amount increases and the phoresis speed is increased compared to the phoretic particles, it is not easy to control the movement degree with respect to an electric field within the required range.

On the other hand, with the dispersion liquid for display according to the exemplary embodiment, since the dispersed floating particles have the surface of core particles including a colorant and a hydrophilic resin covered by a shell including a hydrophobic resin in which the difference in the solubility parameter (SP value) with respect to the dispersion medium is within the range described above, the movement of the floating particles with respect to an electric field in the dispersion medium is suppressed.

Further, since the colorant is not dispersed directly within the hydrophobic resin but the colorant further covers the core particles that are dispersed in the hydrophilic resin using the hydrophobic resin, adjustment of the specific gravity can be performed easily, and precipitation of the floating particles is suppressed.

Here, the SP value in the present specification is obtained by a calculation using a Fedor method, and may also be obtained from known literature (known data collections or the like). Here, the Fedor method can be obtain a value calculated by the basic structure of a chemical substance, and specifically, a value calculated from the values of Ae (evaporation energy of each atom or atomic group) and Δv (mol volume of each atom or atomic group) according to the following formula (reference: Hideki Yamamoto, “SP Value Basics, Application, and Calculation Method”, fourth edition, Joho Kiko Co., Ltd., Apr. 3, 2006, p. 66-67)

SP value (δ)=(ΣΔe/ΣΔv)^{1/2}

Each component configuring the dispersion liquid for display according to the exemplary embodiment will be described below.

### (Floating Particles)

Floating particles are dispersed in the dispersion liquid for display of the exemplary embodiment. The floating particles are particles dispersed in the dispersion medium for the purpose of displaying the background color, and it is preferable that the degree of movement with respect to an electric field be sufficiently lower than for phoretic particles, in order to obtain a favorable display contrast. Specifically, it is desirable that the degree of electrophoretic movement be ⅕ or less that of the phoretic particles, and more preferably 1/10 or less.

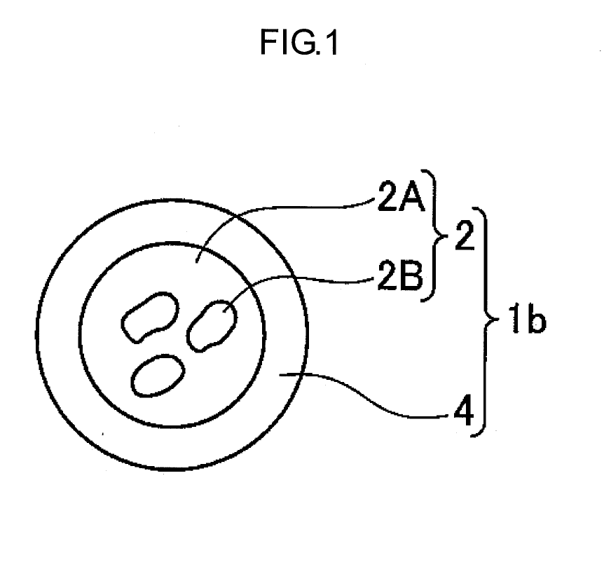

As illustrated in FIG. 1, floating particles lb according to the exemplary embodiment include core particles 2 including a colorant 2B and a hydrophilic resin 2A and a shell 4 covering the surface of the core particles 2 and including a hydrophobic resin in which the difference in the solubility parameter (SP value) with respect to the dispersion medium is within the range described above.

### Core Particles

The hydrophilic resin 2A is contained in the core particles 2. Here, “hydrophilic” refers to being soluble in water, and specifically, indicates a dissolution amount of 2 g or more when 10 g of the resin 2A configuring the core particles 2l is added to 100 ml of pure water and stirred at 25° C.

Here, in a case where whether or not the resin configuring the core particles 2 is hydrophilic is to be verified from the floating particles, verification may be performed by performing the method described above after obtaining the resin configuring the core particles 2, for example, by dissolving the shell 4 and removing the shell 4 using a solvent in which the core particles 2 are not dissolved.

The hydrophilic resin 2A is obtained by copolymerizing one or a plurality of types of monomers. The copolymerization ratio is adjusted so that the copolymer is soluble in water. Here, the hydrophilic resin 2A may be a copolymer salt.

Examples of the monomer that may be used include N,N-dimethyl acrylamide, N,N-dimethylaminoethyl acrylate, N,N-diethyl acrylamide, ethylene imine, amine acrylate, acrylamide, vinylpyridine acrylate, methacrylic acid, maleic acid, vinyl sulfonic acid, styrenesulfonic acid, acrylamidomethylpropane sulfonate, hydroxyethyl(meth)acrylate, (meth)acrylonitrile, (meth)acrylic acid alkyl ester, dialkyl aminoalkyl(meth)acrylate, (meth)acrylamide, ethylene, propylene, butadiene, isoprene, isobutylene, N-dialkyl substituted (meth)acrylamide, vinylcarbazole, styrene, styrene derivatives, ethylene glycol di(meth)acrylate, glyceryl (meth)acrylate, polyethylene glycol mono(meth)acrylate, vinyl chloride, vinylidene chloride, hexanediol di(meth)acrylate, vinyl pyrrolidone, and the like.

Here, in a case where the hydrophilic resin 2A is a copolymer of an ionic monomer and a non-ionic monomer, the copolymerization ratio of the ionic monomer and the non-ionic monomer is adjusted according to the charge amount of the desired particles.

Of the above, a styrene acrylic polymer, polyvinyl pyrrolidone (PVP), polyacrylic acid, polyacrylamide, and polyvinyl alcohol are more preferable.

Further, the hydrophilic resin forming the core particles 2 may have a cross-linked structure.

Examples of method of forming a cross-linked structure include a method of introducing a functional group forming a cross-link in the resin in advance, a method of adding a separate cross-linking agent separately from the resin, and the like.

Here, while the weight-average molecular weight of the hydrophilic resin 2A used for the core particles 2 is not particularly limited, for example, from 2,000 to 500,000 is preferable, and furthermore, from 10,000 to 100,000 is more preferable.

The weight-average molecular weight described above is measured using a static light scattering method or size exclusion column chromatography, and the numerical value described in the present specification is measured using such methods.

The colorant is added for the purpose for coloring the floating particles displaying the background color. In particular, as a white colorant in a case where white floating particles are used, for example, titanium oxide, silicon oxide, zinc oxide, zinc sulfide, alumina, magnesium oxide, zirconium oxide, or the like is used, of which titanium oxide, silicon oxide, or zinc oxide is more preferable.

Further, in a case where floating particles of a color other than white is used, for example, floating particles including a pigment or a dye of the required color are used. Examples of colorants that are applied to floating particles of a color other than white include known colorants such as carbon black, a phthalocyanine copper-based cyan color material, an azo-based yellow color material, an azo-based magenta color material, a quinacridone-based magenta color material, a red color material, a green color material, and a blue color material. Specific examples include aniline blue, calco oil blue, chrome yellow, ultra marine blue, DuPont oil red, quinoline yellow, methylene blue chloride, phthalocyanine blue, malachite green oxalate, lamp black, rose bengal, C.I. pigment red 48:1, C.I. pigment red 122, C.I. pigment red 57:1, C.I. pigment yellow 97, C.I. pigment blue 15:1, C.I. pigment blue 15:3, and the like.

While the amount of colorant contained in the floating particles differs according to the particle diameter of the colorant and the desired color concentration, the amount of colorant is preferably from 5% by mass to 95% by mass with respect to the total solid amount, and furthermore, is preferably form 20% by mass to 50% by mass.

### Shell

A hydrophobic resin is contained in the shell 4. Here, “hydrophobic” refers to being insoluble in water, and specifically refers to a resin in which the dissolution amount when 10 g of the resin configuring the shell 4 is added to 100 ml of pure water and agitated at 25° C. is less than 0.5 g.

### —Difference in Solubility Parameter (SP Value)—

Further, for the hydrophobic resin, the difference in the solubility parameter (SP value) with respect to the dispersion medium applied to the dispersion liquid for display is preferably 7.95 [(J/cm³)^{1/2}] (≈1.9 [(cal/cm³)^{1/2}]) or more. The difference is more preferably 8.37 [(J/cm³)^{1/2}] (≈2.0 [cal/cm³)^{1/2}]) or more, and still more preferably 12.56 [(J/cm³)^{1/2}] (≈3.0 [(cal/cm³)^{1/2}]) or more. Further, while not particularly limited, the upper limit value is preferably 25.12 [(J/cm³)^{1/2}] (≈6.0 [cal/cm³)^{1/2}]) or less.

If the difference in the solubility parameter (SP value) with respect to the dispersion medium is beyond the range described above, suppression of the movement of the floating particles with respect to an electric field is not performed favorably. Although not always clear, it is considered that the hydrophobic resin is compatible with the dispersion medium and the shell 4 absorbs the dispersion medium, and it is conjectured that the colorant is not blocked from the dispersion medium due to the covering of the shell 4, and as a result, suppression of the movement of the floating particles is not performed favorably.

Here, the difference in the solubility parameter (SP value) between the hydrophobic resin and the dispersion medium is controlled by the selection of the type of hydrophobic resin and dispersion medium.

Preferable examples of the hydrophobic resin include polymers derived from a monomer including a vinyl group and a benzene ring.

Examples of monomers including a vinyl group and a benzene ring include styrene, vinyl naphthalene, vinyl biphenyl, triphenyl vinyl silane, vinyl cyclohexane, distyryl naphthalene, methylstyrene, trivinyl cyclohexane, vinyl toluene, trimethyl styrene, vinyl anthracene, and the like. Of the above, styrene, vinyl naphthalene, or vinyl biphenyl is more preferable.

Further, the polymer derived from a monomer including a vinyl group and a benzene ring may be a single polymer of a monomer including the vinyl group and a benzene ring described above, or may be a copolymer with another monomer.

Examples of other monomers used in the synthesis of a copolymer include methacrylic acid, hydroxyethyl methacrylate, a dimethyl silicone monomer (for example, Silaplane FM-0711, FM-0721, FM-0725 manufactured by JNC Corporation), and the like. Among the above methacrylic acid and a dimethyl silicone monomer are more preferable.

Of the above, a copolymer with the following combination is still more preferable,
Copolymer of styrene-methacrylic acid-dimethyl silicone monomer
Copolymer of vinyl naphthalene-methacrylic acid-dimethyl silicone monomer
Copolymer of vinyl biphenyl-methacrylic acid-dimethyl silicone monomer

Here, in the case of a copolymer with another monomer described above, the molar ratio of the monomer including a vinyl group and a benzene ring to all monomer components is preferably from 50% by mole to 99.5% by mole, and more preferably from 50% by mole to 98% by mole.

Further, the hydrophobic resin forming the shell 4 may have a cross-linked structure.

Examples of method of forming a cross-linked structure include a method of introducing a functional group forming a cross-link with the resin in advance, a method of adding a separate cross-linking agent separately from the resin, and the like.

While the weight-average molecular weight of the hydrophobic resin used for the shell 4 is not particularly limited, for example, from 2,000 to 500,000 is preferable, and furthermore, from 10,000 to 100,000 is more preferable.

The weight-average molecular weight described above is measured using a method of the hydrophilic resin described above.

### Preparing Method of Floating Particles

The preparing of the floating particles according to the exemplary embodiment is carried out, for example, by forming the core particles 2 including the colorant 2B and the hydrophilic resin 2A using a known technique (in-liquid drying method, coacervation method, dispersion polymerization method, suspension polymerization method, or the like) or the like, before forming the shell 4 including a hydrophobic resin using a known method (in-liquid drying method, coacervation method, dispersion polymerization method, suspension polymerization method, or the like) or the like.

The preparing method will be described below using one example (a method of forming the core particles 2 using the in-liquid drying method and forming the shell 4 using the coacervation method.

### 1) Creation of Core Particles (In-Liquid Drying Method)

First, an insulating solvent (for example, silicone oil) containing a dispersant is prepared and made into a continuous phase. Next, a dispersed phase is prepared by mixing the hydrophilic resin configuring the core particles with the colorant in a good solvent (for example, water). The continuous phase and the dispersed phase are mixed and emulsified using an emulsifier such as an ultrasonic grinder. Next, the good solvent is removed by stirring and heating while decompressing (for example, 65° C./10 mPa) the obtained emulsified liquid to obtain a particle dispersion liquid in which the core particles are dispersed in the silicone oil. The obtained particle dispersion liquid is substituted with another solvent (for example, a toluene solution) using centrifugation to obtain a core particle dispersion liquid.

Here, an example of an insulating solvent configuring the continuous layer includes a “dispersion medium” described later. Further, examples of the good solvent configuring the dispersed phase described above include, in addition to the water described above, a lower alcohol with five or fewer carbon atoms, tetrahydrofuran (THF), acetone, and the like. Of the above, water is particularly desirable.

### 2) Formation of Shell (Shell) (Coacervation Method)

A hydrophobic resin for shell formation and the core particle dispersion liquid are mixed, and an insulating solvent (for example, silicone oil) is added dropwise to the mixed liquid to precipitate the hydrophobic resin. By then removing the toluene described above by heating and decompressing (for example, 60° C./20 mbar), floating particles in which the shell is formed on the surface of the core particles are obtained.

Here, an example of the insulating solvent described above includes the “dispersion medium” described later.

### Physical Properties of Floating Particles

In the floating particles according to the exemplary embodiment, the surface of the core particles 2 is covered by the shell 4. Here, “covered” refers to at least a coverage ratio of 50% or more, more preferably 80% or more and still more preferably 100%.

Here, the coverage ratio is measured by the following method using TEM image observation, the numerical values described in the present invention being measured using such a method. Measurement is carried out by a silicone oil (KF-96-2cs) solution with a solid concentration of 10% by mass of the floating particles being placed on a grid mesh, the floating particles being observed using a transmission type electron microscope JEM-1010 (manufactured by JEOL Ltd.), and the ratio (average ratio) of portions covered by the shell being calculated. Here, the accelerating voltage is 50 kV.

The thickness of the shell 4 on the floating particles is, for example, preferably from 1 nm to 100 nm, and more preferably from 5 nm to 50 nm.

Further, the volume-average particle diameter of the floating particles is, for example, preferably from 0.05 μm to 1 μm and more preferably from 0.1 μm to 0.5 μm.

Here, the volume-average particle diameter is calculated using a Marquadt analysis method by measuring a scattering intensity distribution through a dynamic light scattering method using a density type particle diameter analyzer FPAR-1000 manufactured by Otsuka Electronics Co., Ltd. The numerical values described in the present specification are measured using the method.

### (Dispersion Medium)

The dispersion medium in which the floating particles according to the exemplary embodiment described above and phoretic particles described later are dispersed is desirably an insulating fluid. Here, “insulating” refers to a volume specific resistance of 10¹¹ Ωcm or more, and is a uniform definition in the present specification.

Specifically, as the insulating fluid described above, hexane, cyclohexane, toluene, xylene, decane, hexadecane, kerosene, paraffin, isoparaffin, silicone oil, dichloroethylene, trichloroethylene, perchloroethylene, high purity oil, ethylene glycol, an alcohol, an ether, an ester, dimethyl formamide, dimethyl acetoamide, dimethyl sulfoxide, N-methyl pyrrolidone, 2-pyrrolidone, N-methyl formamide, acetonitrile, tetrahydrofuran, propylene carbonate, ethylene carbonate, benzene, diisopropyl naphthalene, olive oil, isopropanol, trichlorotrifluoroethane, tetrachloroethane, dibromotetrafluoroethane, and the like, and mixtures thereof are favorably used. Among the above, silicone oil is preferably applied.

Further, by removing impurities to obtain the following volume resistivity value, water (so-called pure water) is also used favorably as a dispersion medium. The volume resistivity value is desirably 10³ Q. cm or more, from 10⁷ Ωcm to 10¹⁹ Ωcm is more favorable, and furthermore, from 10¹⁰ Ωcm to 10¹⁹ Ωcm is even more preferable.

Here, while an acid, an alkali, a salt, a dispersion stabilizer, and a stabilizer, a stabilizer with the purpose for oxidization prevention or ultraviolet absorption, an antiseptic agent, a preservative agent, and the like may be added to the insulating fluid described above as necessary, it is desirable that the addition be performed so that the volume resistivity value is within the specific range described above.

Further, the insulating fluid may be used by adding, as a charge control agent, an anionic surfactant, an ionic surfactant, an ampholytic surfactant, a non-ionic surfactant, a fluorine-based surfactant, a silicone-based surfactant, a metallic soap, an alkyl phosphate ester, a succinic acid imide, and the like.

The following are specific examples of ionic and non-ionic surfactants. Examples of non-ionic surfactants include polyoxyethylene nonylphenyl ether, polyoxyethylene octylphenyl ether, polyoxyethylene dodecylphenyl ether, polyoxyethylene alkyl ether, polyoxyethylene fatty acid ester, fatty acid alkylolamide, and the like. Examples of anionic surfactants include alkylbenzene sulfonate, alkylphenyl sulfonate, alkylnaphthalene sulfonate, higher fatty acid salts, sulfuric acid ester salts of higher fatty acid esters, sulfate of higher fatty acid esters, and the like. Examples of cationic surfactants include primary to tertiary amine salts, quaternary ammonium salt, and the like.

Here, the dispersion medium may use a polymer resin together with the insulating fluid. The polymer resin is desirably also a polymer gel, a macromolecule polymer, or the like.

Examples of polymer resins include polymer gels derived from natural polymer such as agarose, agaropectin, amylose, sodium alginate, propylene glycol alginate ester, isolichenan, insulin, ethyl cellulose, ethylhydroxyethyl cellulose, curdlan, casein, carrageenan, carboxymethyl cellulose, carboxymthyl starch, callose, agar, chitin, chitosan, silk fibroin, guar gum, quince seed, crown gall polysaccharide, glycogen, glucomannan, keratan sulfate, keratin protein, collagen, cellulose acetate, gellan gum, schizophyllan, gelatin, ivory palm mannan, tunicin, dextran, dermatan sulfate, starch, tragacanth, Nigeran, hyaluronic acid, hydroxyethyl cellulose, hydroxypropyl cellulose, pustulan, funoran, degradation xyloglucan, pectin, prophyllan, methyl cellulose, methyl starch, laminaran, lichenan, lentinan, locust bean gum, and almost all polymer gels in the case of a synthetic polymer.

Furthermore, examples include polymers and the like including an alcohol, ketone, ether, ester, and amide functional groups in repeating units, examples of which include polyvinyl alcohol poly(meth)acrylamide, a derivative thereof, polyvinyl pyrrolidone, polyethylene oxide, and copolymer including such polymers.

Of the above, gelatin, polyvinyl alcohol, poly(meth)acrylamide, and the like are desirably used.

Further, a different color from the color of the phoretic particles or floating particles may be displayed on the electrophoretic display medium by mixing the following colorants with the dispersion medium.

Examples of colorants to be mixed with the dispersion medium include known colorants such as carbon black, titanium oxide, magnesium oxide, zinc oxide, a phthalocyanine copper-based cyan color material, an azo-based yellow color material, an azo-based magenta color material, a quinacridone-based magenta color material, a red color material, a green color material, and a blue color material. Specifically, typical examples include aniline blue, calco oil blue, chrome yellow, ultramarine blue, DuPont oil red, quinoline yellow, methylene blue chloride, phthalocyanine blue, malachite green oxalate, lamp black, rose bengal, C.I. pigment red 48:1, C.I. pigment red 122, C.I. pigment red 57:1, C.I. pigment yellow 97, C.I. pigment blue 15:1, C.I. pigment blue 15:3, and the like.

Since the phoretic particles move within the dispersion medium, the viscosity in an environment of 20° C. is desirably from 0.1 mPa·s to 100 mPa·s, more desirably from 0.1 mPa·s to 50 mPa·s, and still more desirably from 0.1 mPa·s to 20 mPa·s.

Adjustment of the viscosity of the dispersion medium is performed by adjusting the molecular weight, the structure, the composition, and the like of the dispersion medium. Here, a B-8 type viscometer manufactured by Tokyo Keiki Inc. is used in the measurement of the viscosity.

### (Phoretic Particles)

The phoretic particles are charged, and are particles that move within the dispersion medium by a specified voltage being applied between a pair of substrates and an electric field of a specified electric field intensity or greater being formed between the substrates. Changes in the display color on the electrophoretic display medium occur due to the movement of each particle configuring the phoretic particles within the dispersion medium.

Examples of the phoretic particles include insulating metallic oxide particles and the like such as glass beads, alumina, and titanium oxide, thermoplastic or thermoplastic particles, those in which a colorant is fixed to the surface of such resin particles, particles containing a colorant within a thermoplastic or thermosetting resin, metallic colloid particles with a plasmon coloring function, and the like.

Examples of thermoplastic resins used in the manufacture of the phoretic particles include single polymers and copolymers of styrenes such as styrene and chlorostyrene, monoolefins such as ethylene, propylene, butylene, and isoprene, vinyl esters such as vinyl acetate, vinyl propionate, vinyl benzoate, vinyl butyrate, a-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate, vinyl esters such as vinyl methyl ether, vinyl ethyl ether, and vinyl butyl ether, and vinyl ketones such as vinyl methyl ketone, vinyl hexyl ketone, and vinyl isopropenyl ketone.

Further, examples of thermosetting resins used in the formation of the phoretic particles include cross-linked resins such as a cross-linked copolymer with divinyl benzene as the principal component and cross-linked polymethyl methacrylate, a phenol resin, a bromine resin, a melamine resin, a polyester resin, a silicone resin, and the like. In particular, typical binder resins include polystyrene, a styrene-alkyl acrylate copolymer, a styrene-alkyl methacrylate copolymer, a styrene-acrylonitrile copolymer, a styrene-butadiene copolymer, a styrene-malic acid anhydride copolymer, polyethylene, polypropylene, polyester, polyurethane, an epoxy resin, a silicone resin, polyamide, modified rosin, paraffin wax, and the like.

Organic or inorganic pigments, oil-soluble dyes, and the like are used as the colorant, examples of which include known colorants such as magnetic powders such as magnetite and ferrite, carbon black, titanium oxide, magnesium oxide, zinc oxide, a phthalocyanine copper-based cyan color material, an azo-based yellow color material, an azo-based magenta color material, a quinacridone-based magenta color material, a red color material, a green color material, and a blue color material. Specifically, typical examples include aniline blue, calco oil blue, chrome yellow, ultramarine blue, DuPont oil red, quinoline yellow, methylene blue chloride, phthalocyanine blue, malachite green oxalate, lamp black, rose bengal, C.I. pigment red 48:1, C.I. pigment red 122, C.I. pigment red 57:1, C.I. pigment yellow 97, C.I. pigment blue 15:1, C.I. pigment blue 15:3, and the like.

A charge controlling agent may be mixed into the resin of the phoretic particles. Known charge controlling agents such as those used as the toner material for electrophotography are used, examples of which include quaternary ammonium salts such as cetyl pyridyl chloride, quaternary ammonium salts such as BONTRON P-51, BONTRON P-53, BONTRON E-84, and BONTRON E-81 (all of which are manufactured by Orient Chemical Industries Co., Ltd.), a salicylic acid-based metallic complex, a phenol-based condensate, a tetraphenyl-based compound, metal oxide particles, and metal oxide particles that are surface-treated using various coupling agents.

A magnetic material may be mixed on the inside or the surface of the phoretic particles. An inorganic magnetic material or an organic magnetic material is used as the magnetic material, and such magnetic materials may be color coated. Further, a transparent magnetic material, particularly a transparent organic magnetic material is more desirable.

As a colored magnetic powder, for example, a small diameter colored magnetic powder described in JP-A-2003-131420 may be used. One including magnetic particles as the nucleus and a colored layer laminated on the surface of the magnetic particles is used. Furthermore, while the colored layer may be selected by coloring the magnetic powder to be impermeable or the like using a pigment or the like, using a light interference thin film, for example, is desirable. The light interference thin film is an achromatic color material such as SiO₂ and TiO₂ that is a thin film with the same thickness as the wavelength of light, and wavelength-selectively reflects light through light interference within the thin film.

An external additive may be attached to the surface of the phoretic particles. The color of the external additive is desirably transparent so that the color of the particles is not affected. Examples of external additives include inorganic particles such as metal oxides such as silicon oxide (silica), titanium oxide, and alumina.

Further, the phoretic particles may also be surface treated using a coupling agent or a silicone oil. Among coupling agents, there are positively charged coupling agents such as an amino silane-based coupling agent, an amino titanium-based coupling agent, and a nitrile-based coupling agent, and negatively charge coupling agents not including nitrogen atoms (configured by atoms other than nitrogen) such as a silane-based coupling agent, a titanium-based coupling agent, an epoxy silane coupling agent, and an acryl silane coupling agent. Further, among silicone oils, there are positively charged silicone oils such as an amino-modified silicone oil, and negatively charged silicone oils such as a dimethyl silicone oil, an alkyl-modified silicone oil, an cc-methyl sulfone-modified silicone oil, a methylphenyl silicone oil, a chlorophenyl silicone oil, and a fluorine-modified silicone oil. The above are selected according to the resistance of the external additive.

Of the external additives described above, the well-known hydrophobic silica or hydrophobic titanium oxide is desirable, and in particular, a titanium compound obtained by a reaction between the TiO(OH)₂ described in JP-A-10-3177 and a silane compound such as a silane coupling agent is favorable. As the silane compound, any type of chlorosilane, alkoxy silane, silazane, or a special silylating agent may be used. The titanium compound is created by reacting and drying a silane compound or a silicone oil with TiO(OH)₂ created during a wet process.

While the primary particles of the external additive are generally from 1 nm to 100 nm and preferably from 5 nm to 50 nm, the primary particles are not limited thereto.

The composition ratio between the external additive and the phoretic particles is adjusted as a balance between the particle diameter of the phoretic particles and the particle diameter of the external additive. Generally, the amount of external additive is desirably from 0.01 parts by mass to 3 parts by mass with respect to 100 parts by mass of the phoretic particles, and more desirably from 0.05 parts by mass to 1 part by mass.

In a case where phoretic particles with a plurality of types of colors and different charge characteristics are used, an external additive may be added to only any one type of the plurality of types of phoretic particles, or may be added to a plurality of types or all types of phoretic particles. In a case where an external additive is added to the surface of all phoretic particles, it is desirable that the external additive be driven onto the surface of the phoretic particles using the force of impact, or the external additive be strongly fixed to the surface of the phoretic particles by heating the surface of the phoretic particles.

As a method for preparing the phoretic particles, any known method of the related art may be used. For example, as described in JP-A-7-325434, a method of calculating the amount of a resin, a pigment, and a charge controlling agent to obtain a predetermined mixture ratio, adding the pigment after heating and melting the resin and mixing, dispersing, and cooling, and preparing the particles using a crusher such as a jet mill, a hammer mill, or a turbo mill, and dispersing the obtained particles thereafter in a dispersion medium is used. Further, a particle dispersion medium may be created by preparing particles containing a charge controlling agent within the particles using a polymerization method such as suspension polymerization, emulsification polymerization, and dispersion polymerization, coacervation, melt dispersion, or an immersion aggregation method, and then dispersing the particles in the dispersion medium. Furthermore, there is a method of using an appropriate device dispersing and kneading the raw materials of a resin, a colorant, a charge controlling agent, and a dispersion medium at a temperature at which the resin can thermoset, the dispersion medium does not boil, and which is also lower than the decomposition point of at least one of the resin, the charge controlling agent, and the colorant. Specifically, the particles are prepared by heat melting a pigment, the resin, and the charge controlling agent within the dispersion medium using a meteor type mixer, a kneader, or the like, and cooling while agitating the melt mixture using the temperature dependence of the solvent solubility of the resin to coagulate and precipitate the particles.

Further, a method of putting the raw materials described above into an appropriate container equipped with granular media for dispersal and kneading, for example, a heated vibration mill such as an attritor or a heated ball mill, and dispersing and kneading the container within a desired temperature range, for example, from 80° C. to 160° C., may be used. As the granular media, steels such as stainless steel and carbon steel, alumina, zirconia, silica, or the like is desirably used. In order to prepare the particles using such a method, after further dispersing the raw materials put in a fluidized state in advance within the container using the granular media, the dispersion medium is cooled, and a resin including a colorant is precipitated from the dispersion medium. The particle diameter is decreased by shearing and/or generating an impact on the granular media while continuing to maintain the state of motion during cooling and after cooling.

The content amount of the phoretic particles (the content amount (% by mass) with respect to the total mass within the cell of the electrophoretic display medium) is not particularly limited as long as the phoretic particles are at a concentration at which the desired color phase is obtained, and it is effective for the electrophoretic display medium to adjust the content amount by the thickness of the cell (that is, the distance between a pair of substrates). That is, in order to obtain the color phase described above, the thicker the cell, the smaller the content amount, and the thinner the cell, the greater the content amount. Generally, the content amount is from 0.01% by mass to 50% by mass.

### (Display Medium)

The display medium according to the exemplary embodiment includes a pair of substrates in which at least one is light transmissive, and the dispersion liquid for display according to the exemplary embodiment described above sealed between the pair of substrates.

Each member other than the dispersion liquid for display of the display medium according to the exemplary embodiment will be described below. Substrates

First, the pair of substrates will be described. At least one of the substrates is light transmissive and acts as the substrate on the display side, on which an image is visible. Here, light transmissivity in the exemplary embodiment refers to a transmittance of visible light of 60% or more.

Examples of the substrates include glass and plastics such as a polyethylene terephthalate resin, a polycarbonate resin, an acrylic resin, a polyimide resin, a polyester resin, an epoxy resin, a polyether sulfonic resin, and the like.

Further, electrodes are provided on the substrates. As the electrodes, oxides of indium, tin, cadmium, and antimony, or the like, complex oxides such as ITO, metals such as gold, silver, copper, and nickel, organic materials such as polypyrrole and polythiophene, and the like are used. Such materials are used as a single layer film, a mixed film, or a complex film, and are formed using a deposition method, a sputtering method, a coating method, or the like. Further, the thickness thereof according to a deposition method or a sputtering method is usually from 100 A to 2000 Å. The electrodes are formed through a known technique of the related art such as etching of a liquid crystal display medium or a print substrate of the related art into a predetermined pattern, for example, in a matrix pattern or a striped pattern with which passive matrix driving is possible. Further, the electrodes may be embedded in the substrates.

Here, each of the electrodes provided on the pair of substrates may be respectively separated from each substrate and arranged on the outside of the display medium.

Here, the electrodes may be provided on both substrates, or may be provided on only one of the substrates and active matrix-driven.

Further, in order to perform active matrix driving, the substrates may be provided with a TFT (Thin Film Transistor) for each pixel.

### Gap Member

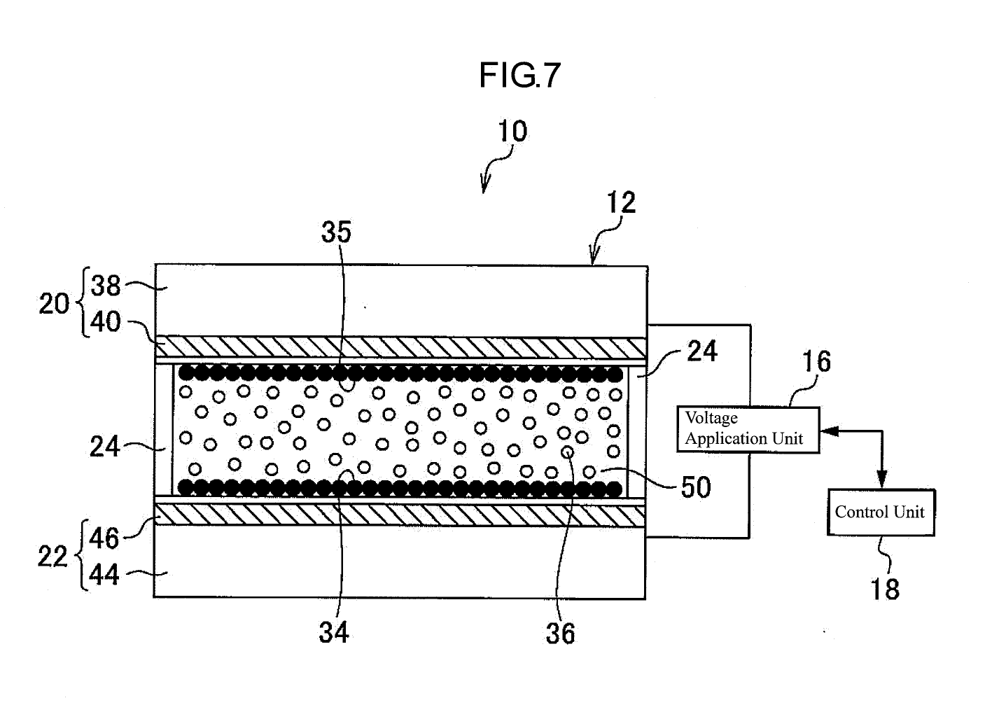

The gap member (for example, 24 in FIGS. 7 to 10) for maintaining a gap between the pair of substrates are formed so that the light transmissivity of the substrates is not lost, and is formed by a thermoplastic resin, a thermosetting resin, an electron beam curable resin, a light curable resin, rubber, a metal, or the like.

The gap member may be integrated with either one of the substrates. In such a case, the gap member is formed by performing an etching process of etching the substrate, a laser treatment process, a press treatment process using a mold formed in advance, a printing process, or the like. In such a case, the gap member is formed on one or both of the substrates.

While the gap member may be colored or colorless, it is desirably colorless and transparent so that an image to be displayed on the display medium is not negatively affected, and in such a case, a transparent resin or the like such as, for example, polystyrene, polyester, or acryl is used.

Further, a granular gap member is also desirably transparent, transparent resin particles such as polystyrene, polyester, and acryl, as well as glass particles are used.

Here, “transparent” refers to a transmittance with respect to visible light of 60% or more.

### Voltage Application Unit and Control Unit

A voltage application unit (voltage application device) is electrically connected to the electrodes. Here, while a case where both of the electrodes are electrically connected to the voltage application unit will be described in the exemplary embodiment, a configuration in which one of the electrodes is grounded and the other is connected to the voltage application unit is also possible.

The voltage application unit is connected to be able to transmit and receive signals to and from the control unit.

The control unit may be configured as a microcomputer including a CPU (Central Processing Unit) controlling the operation of the entire device, a RAM (Random Access Memory) temporarily storing various pieces of data, and a ROM (Read Only Memory) in which various programs such as a control program controlling the entire device are stored in advance.

The voltage application unit is a voltage application device for applying a voltage to the electrodes, and applies a voltage according to the control of the control unit between the electrodes.

### Display Medium

The size of the cell of the display medium described above has a close relationship with the resolution of the display medium, and the smaller the cell, the greater the resolution of an image that can be displayed by the display medium to be created, and the length of the display medium in the plate face direction of the substrate is usually from 10 μm to 1 mm.

In order to fix the substrates to each other via the gap member, a fixing unit such as a combination of bolts and nuts, clamps, clips, and substrate fixing frames is used. Further, fixing units such as an adhesive, heat melting, and ultrasonic bonding may also be used.

An electrophoretic display medium configured in such a manner is used, for example, in a bulletin board on which an image can be saved and rewritten, a circular notice, an electric blackboard, an advertisement, a sign, a flashing label, electronic paper, an electronic newspaper, an electronic book, a document sheet in which a copier and a printer are combined, and the like.

### Behavior of Phoretic Particles

Here, the behavior of the phoretic particles within the electrophoretic display medium according to the exemplary embodiment will be described.

### (a) Where One Type (One Color) of Phoretic Particles is Included

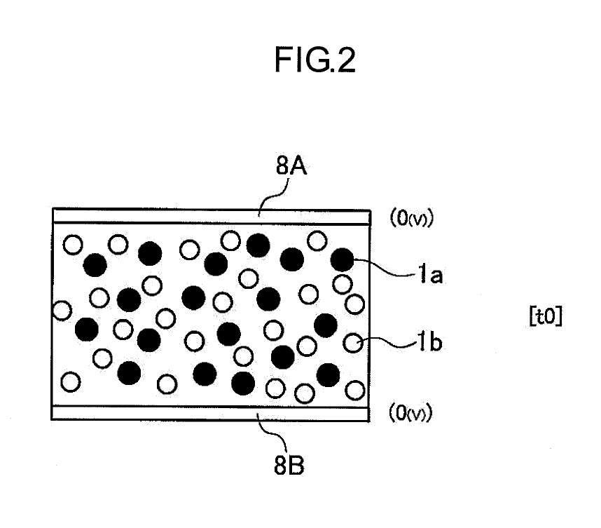

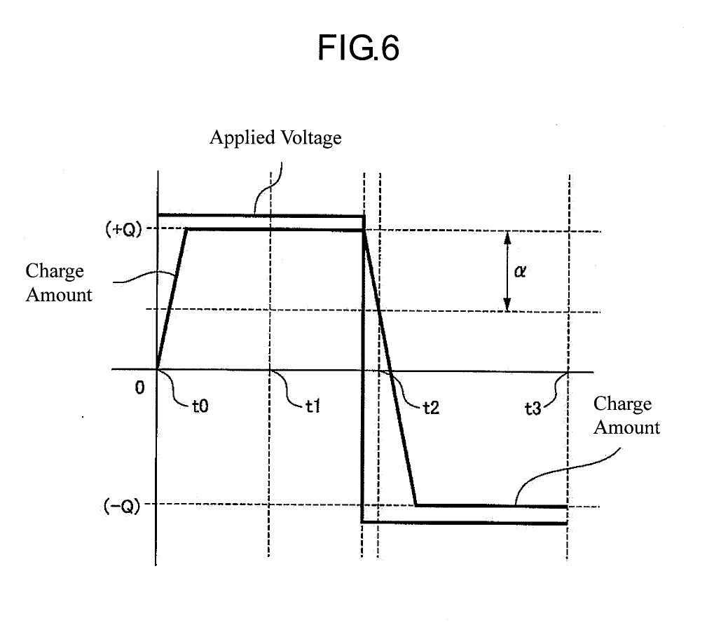

Here, in a display medium including the dispersion liquid for display according to the exemplary embodiment containing one type of phoretic particles, the behavior of the phoretic particles (negatively charged particles) according to the applied voltage will be described using FIGS. 2 to 5. Here, the relationship between the voltage (rectangular wave) and the charge amount applied together is illustrated in FIG. 6. Further, the dispersion liquid for display according to the exemplary embodiment described above in which phoretic particles 1a and floating particles lb are dispersed within the dispersion medium is filled between electrodes 8A and 8B (that is, within the cell) illustrated in FIGS. 2 to 5.

First, what is illustrated in FIG. 2 is the state of tO in FIG. 6 in which a voltage has not been applied to the electrodes 8A and 8B on the electrophoretic display medium, and is a state in which the phoretic particles 1a is dispersed.

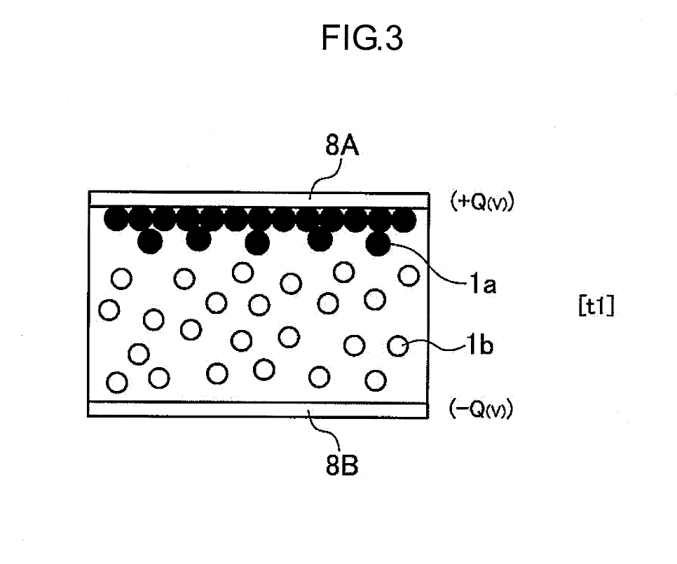

Here, in the state of tl in FIG. 6, that is, by applying a voltage of +Q (V) (Q: voltage equal to or greater than a threshold voltage of the phoretic particles) or more to the electrode 8A while applying a voltage of −Q (V) or less to the electrode 8B, the phoretic particles 1a move to the electrode 8A side (FIG. 3).

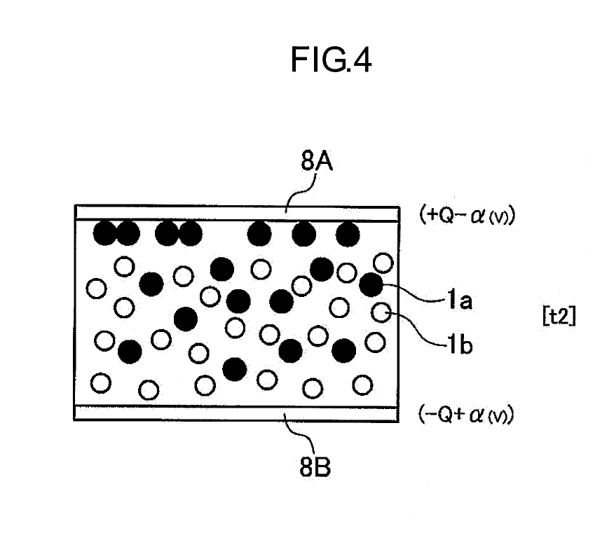

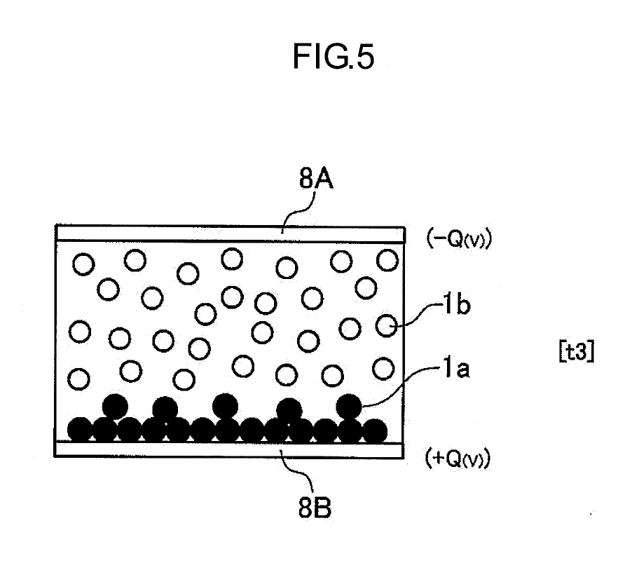

Next, in the state of t2 in FIG. 6, that is, by applying a voltage of −Q (V) or less to the electrode 8A while applying a voltage +Q (V) or more to the electrode 8B, the phoretic particles 1a start to peel off from the electrode 8A (FIG. 4), further, in the state of t3 in FIG. 6, the phoretic particles 1a move to the electrode 8B side (FIG. 5).

By controlling the voltage applied to the electrodes 8A and 8B as described above, the behavior of the phoretic particles 1a is adjusted. At this time, for example, if the voltage 8A side is the side on which an image is displayed, the color of the phoretic particles 1a is visible in the state of tl, the color of the phoretic particles 1a is not visible in the state of t3, and the color of the floating particles lb dispersed in the dispersion medium is visible.

### (b) Where Two Types (Two Colors) of Phoretic Particles are Included

Next, in a display medium including the dispersion liquid for display according to the exemplary embodiment containing two types of phoretic particles, the behavior of the two types of phoretic particles described above (particles in which one type is positively charged and the other type is negatively charged) according to the applied voltage will be described using FIGS. 7 to 10.

Here, a display device 10 illustrated in FIGS. 7 to 10 is configured to include a display medium 12, a voltage application unit 16 applying a voltage to the display medium 12, and a control unit 18. The display medium 12 is configured to include a display substrate 20 as the image display face, a reverse substrate 22 opposing the display substrate 20 with a gap therebetween, a gap member 24 maintaining a fixed gap between the substrates while dividing the space between the display substrate 20 and the reverse substrate 22 into a plurality of cells, phoretic particles 34 (positively charged) sealed within each cell, and phoretic particles 35 (negatively charged) with a different color from the phoretic particles 34.

The dispersion liquid for display according to the exemplary embodiment is sealed within each cell. That is, a dispersion medium 50 is sealed within the cells and the phoretic particles 34 and 35 are dispersed within the dispersion medium 50, and the floating particles 36 according to the exemplary embodiment described above are dispersed.

First, in a state in which a+voltage that is greater than the threshold voltage of the phoretic particles 35 (high threshold voltage) is applied to a surface electrode 40 while a−voltage that is greater than the threshold voltage of the phoretic particles 35 (high threshold voltage) to a reverse electrode 46, as illustrated in FIG. 7, the phoretic particles 34 (positively charged) move to the reverse electrode 46 side, and the phoretic particles 35 (negatively charged) move to the surface electrode 40 side. Here, the color that is visible from the surface electrode 40 side is only the color of the phoretic particles 35.

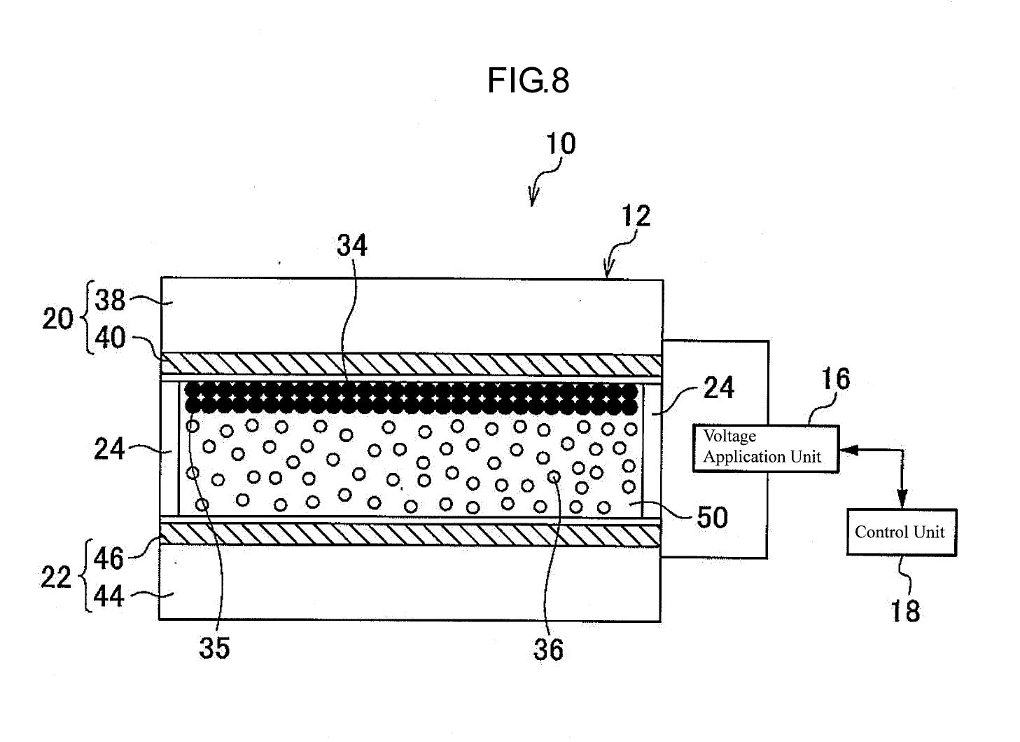

Here, in a state in which a+voltage that is greater than the threshold voltage of the phoretic particles 34 (low threshold voltage) and lower than the threshold voltage of the phoretic particles 35 (high threshold voltage) is applied to the reverse electrode 46 while a−voltage that is greater than the threshold voltage of the phoretic particles 34 (low threshold voltage) and lower than the threshold voltage of the phoretic particles 35 (high threshold voltage) is applied to the surface electrode 40, as illustrated in FIG. 8, only the phoretic particles 34 (positively charged) move to the surface electrode 40 side while the phoretic particles 35 (negatively charged) are still retained on the surface electrode 40 side. Here, the color that is visible from the surface electrode 40 side is a mixed color of the phoretic particles 34 and 35.

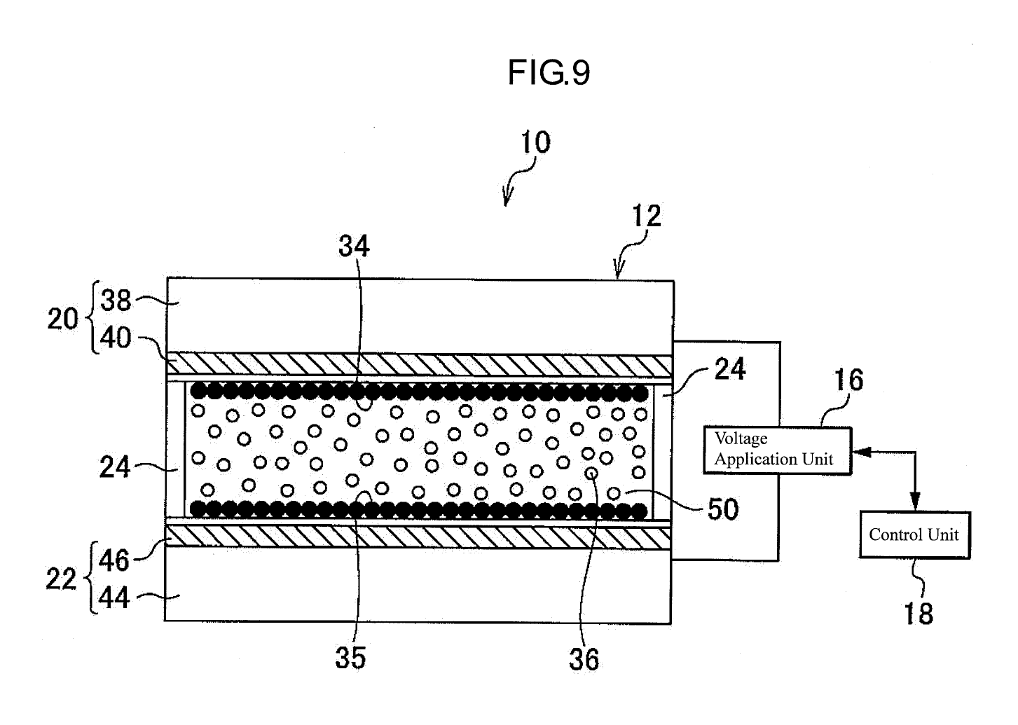

Next, in a state in which a+voltage that is greater than the threshold voltage of the phoretic particles 35 (high threshold voltage) is applied to the reverse electrode 46 while a−voltage that is greater than the threshold voltage of the phoretic particles 35 (high threshold voltage) is applied to the surface electrode 40, as illustrated in FIG. 9, the phoretic particles 35 (negatively charged) move to the reverse electrode 46 side while the phoretic particles 34 (positively charged) are still retained on the surface electrode 40 side. Here, the color that is visible from the surface electrode 40 side is only the color of the phoretic particles 34.

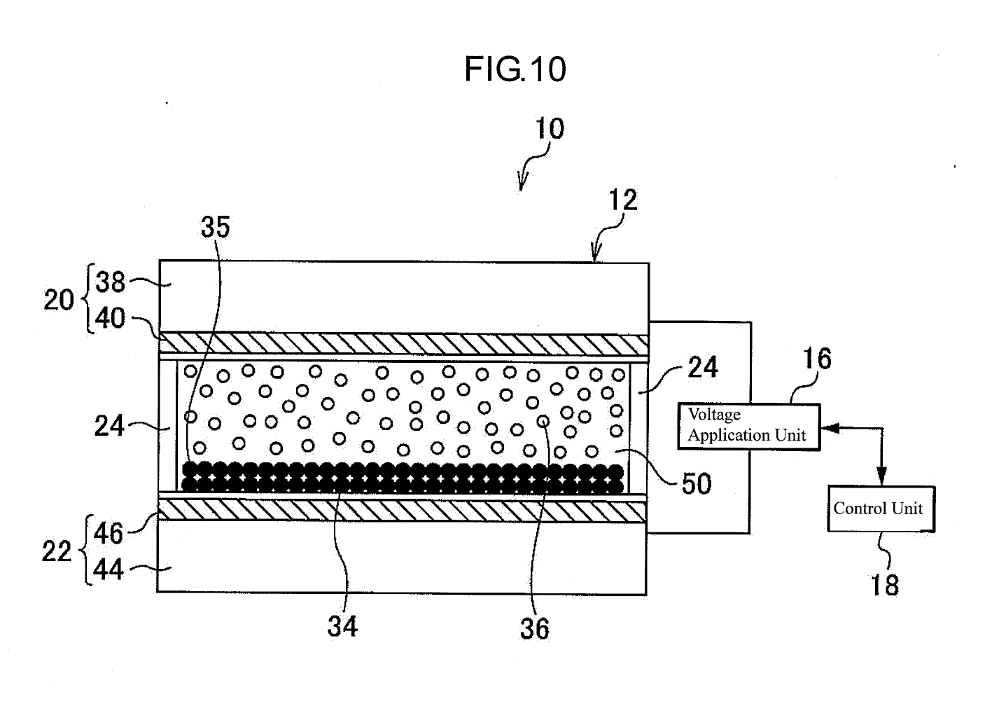

Furthermore, in a state in which a−voltage that is greater than the threshold voltage of the phoretic particles 34 (low threshold voltage) and lower than the threshold voltage of the phoretic particles 35 (high threshold voltage) is applied to the reverse electrode 46 while a+voltage that is greater than the threshold voltage of the phoretic particles 34 (low threshold voltage) and lower than the threshold voltage of the phoretic particles 35 (high threshold voltage) is applied to the surface electrode 40, as illustrated in FIG. 10, only the phoretic particles 34 (positively charged) move to the reverse electrode 46 side while the phoretic particles 35 (negatively charged) are still retained on the reverse electrode 46 side. Here, neither the color of the phoretic particles 34 nor the color of the phoretic particles 35 is visible from the surface electrode 40 side, and only the color of floating particles 36 dispersed within a dispersion medium 50 is visible.

### EXAMPLES

The present invention will be described more specifically below using examples.

### Example 1

### —Formation of Titanium Oxide-Containing White Floating Particles—

### 1) Formation of Core Particles (In-Liquid Drying Method)

### Formation of Continuous Phase

The following materials are mixed to synthesize a polymer dispersant El through radical solution polymerization (55° C./6 hours).

Silicon macro monomer (product name FM-0711, Mn=1,000, manufactured by JNC Corporation): 36 parts by mass

Methacrylic acid: 0.35 parts by mass

Silicone oil (KF-96-2CS, manufactured by Shin-Etsu Chemical Co., Ltd.): 40 parts by mass

Polymerization initiator (2,2′-azobis (2,4-dimethylvaleronitrile), manufactured by Wako Pure Chemical Industries, Ltd., V-65): 0.06 parts by mass

A solution Al (continuous phase) including a polymer dispersant El is prepared by dilution using a dimethyl silicone oil (KF-96-2CS manufactured by Shin-Etsu Chemical Co., Ltd.) to obtain 3 parts by mass of the polymer reaction components.

### Formation of Dispersed Phase

Zirconium beads are added to a mixture of 10 parts by mass of a styrene acrylic polymer (X-1202L manufactured by Seiko PMC Corporation), 10 parts by mass of titanium dioxide (white colorant, TTO-55A manufactured by Ishihara Sangyo Kaisha, Ltd.), and 90 parts by mass of water and a dispersion process is performed for one hour using a rocking mill to obtain a solution B1 (dispersed phase).

### Emulsification and In-Liquid Drying Process

An emulsified liquid is prepared by mixing 80 parts by mass of the solution Al (continuous phase) and 20 parts by mass of the solution B1 (dispersed phase). Emulsification is performed at 20,000 rpm/10 minutes using an omnihomogenizer GLH-115.

Next, the obtained emulsified liquid is placed in an eggplant flask and the water is removed by heating (65° C.) and decompressing (10 mPa) using an evaporator while stirring to obtain a particle dispersion liquid in which particles (core particles) in which titanium dioxide is dispersed within styrene acrylic polymer are dispersed in silicone oil. The obtained particle dispersion liquid is substituted into a toluene solution using centrifugation and adjusted so that the particle solid concentration is 20% by mass to obtain a core particle toluene dispersion liquid Cl.

### Verification of Solubility of Hydrophilic Resin in Water

The solubility of the resin in water is investigated in order to verify whether or not the styrene acrylic polymer configuring the core particles is hydrophilic. Specifically, when the dissolution amount when 10 g of the styrene acrylic polymer is added to 100 ml of pure water and stirred at 25° C. is investigated, it is verified that the 10 g has dissolved and is hydrophilic.

### 2) Shelling Process (Coacervation Method)

### Synthesis of Shell Resin

Styrene (manufactured by Wako Pure Chemical Industries, Ltd.): 70 parts by mass

Silaplane FM-0721 (manufactured by JNC Corporation, weight-average molecular weight Mw=5000): 25 parts by mass

Methacrylic acid (manufactured by Tokyo Chemical Industry Co., Ltd.): 5 parts by mass

Lauroyl peroxide (manufactured by Sigma-Aldrich Corporation): 1 part by mass

Toluene (manufactured by Kanto Chemical Co., Inc.): 100 parts by mass

After mixing each material with the composition described above and heating at 75° C. for 6 hours, the mixture is added dropwise to isopropyl alcohol (manufactured by Kanto Chemical Co., Inc.) and purified through a reprecipitation method to obtain a white solid (shell resin/weight-average molecular weight Mw=30000).

### Shelling Process

Shell resin: 10 parts by mass
Core particle toluene dispersion liquid C1 (particle solid concentration 20% by mass): 50 parts by mass

The shell resin is precipitated by mixing each material with the composition described above and adding 200 parts by mass of the silicone oil KF-96L-2cs (manufactured by Shin-Etsu Chemical Co., Ltd.) dropwise. By then removing the toluene at 60° C. and 20 mbar using an evaporator, a floating particle dispersion liquid containing titanium oxide-containing white floating particles in which a shell is formed on the core particle surface is obtained.

### Verification of Solubility of Hydrophobic Resin in Water

The solubility of the resin in water is investigated in order to verify whether or not the copolymer of the shell resin configuring the shell is hydrophobic. Specifically, the dissolution amount when 10 g of the shell resin is added to 100 ml of pure water and stirred at 25° C. is investigated. The resin has substantially precipitated, and there is no resin (undetectable) when the supernatant solubility after centrifugation is investigated, and it is verified that the resin is hydrophobic.

### Difference in SP Values

The difference in the solubility parameter (SP value) between the copolymer of the shell resin configuring the shell and the silicone oil KF-96L-2cs as the dispersion medium is calculated using the Fedor method described above. The SP value of the silicone oil KF-96-2CS is 30.56 [(J/cm³)^{1/2}](≈7.3 [(cal/cm³)^{1/2}]) and the SP value of the shell resin is 42.11 [(J/cm³)^{1/2}] (≈10.06 [(cal/cm³)^{1/2}]) and the difference in the SP values is 11.55 [(J/cm³)^{1/2}] (≈2.76 [(cal/cm3)^{1/2}]).

The calculation result of the difference in the SP values is 11.55 [(J/cm³)^{1/2}] (≈2.76 [cal/cm³)^{1/2}]).

The calculation result of the difference in the solubility parameter (SP value) is also shown in the following Table 1.

### Coverage Ratio

The coverage ratio of the core particles by the shell resin is calculated by the method described above through TEM observation. The calculation result of the coverage ratio is shown in the following Table 1.

### Example 2

Evaluation is performed in a similar manner to Example 1 except that the solvent is changed from the silicone oil KF-96-2cs to Isopar M (manufactured by Exxon Mobil Corporation, SP value: 29.3 [(J/cm³)^{1/2}] (≈7.0 [cal/cm³)^{1/2}]). The result is shown in the following Table 1.

### Example 3

Evaluation is performed in a similar manner to Example 1 except that the core resin is changed from the styrene acrylic polymer (X-1202L manufactured by Seiko PMC Corporation) to polyvinylpyrrolidone (PVP K30 manufactured by Wako Pure Chemical Industries, Ltd.). The result is shown in the following Table 1.

### Example 4

Evaluation is performed in a similar manner to Example 1 except that after each material is mixed with the following composition and heated for six hours at 75° C., the mixture is added dropwise to methanol (manufactured by Kanto Chemical Co., Inc.) and purified through a reprecipitation method to obtain a white solid (shell resin/weight-average molecular weight Mw=50000). The result is shown in the following Table 1.

### Synthesis of Shell Resin

Styrene (manufactured by Wako Pure Chemical Industries, Ltd.): 50 parts by mass

Silaplane FM-0721 (manufactured by JNC Corporation, weight-average molecular weight Mw=5000): 45 parts by mass

Methacrylic acid (manufactured by Tokyo Chemical Industry Co., Ltd.): 5 parts by mass

Lauroyl peroxide (manufactured by Sigma-Aldrich Corporation): 1 part by mass

Toluene (manufactured by Kanto Chemical Co., Inc.): 100 parts by mass

### Example 5

Evaluation is performed in a similar manner to Example 1 except that after each material is mixed with the following composition and heated for six hours at 75° C., the mixture is added dropwise to methanol (manufactured by Kanto Chemical Co., Inc.) and purified through a reprecipitation method to obtain a white solid (shell resin/weight-average molecular weight Mw=50000). The result is shown in the following Table 1.

### Synthesis of Shell Resin

Styrene (manufactured by Wako Pure Chemical Industries, Ltd.): 40 parts by mass

Silaplane FM-0721 (manufactured by JNC Corporation, weight-average molecular weight Mw=5000): 55 parts by mass

Methacrylic acid (manufactured by Tokyo Chemical Industry Co., Ltd.): 5 parts by mass

Lauroyl peroxide (manufactured by Sigma-Aldrich Corporation): 1 part by mass

Toluene (manufactured by Kanto Chemical Co., Inc.): 100 parts by mass

### Comparative Example 1

The floating particle dispersion liquid is obtained through the method described in Example 1 except that up to “1) creation of the core particles (in-liquid drying method)” of Example 1 is performed and “2) shelling process (coacervation method)” is not performed, that is, the titanium oxide-containing white floating particles formed of only the core particles without forming the shell are obtained.

### Comparative Example 2

### 1) Creation of Dispersant A

A solution in which 14 parts by mass of a methacryloxypropyl modified silicone (Silaplane FM-0721 manufactured by JNC Corporation), 6 parts by mass of dimethylaminoethyl methacrylate (manufactured by Tokyo Keiki Inc.), and 0.1 parts by mass of azobisdimethylvaleronitrile as a polymerization initiator are dissolved in 180 parts by mass of a silicone oil (KF-96-1cs manufactured by Shin-Etsu Chemical Co., Ltd.) is put in a reaction vessel including an stirrer, a thermometer, and a reflux condenser and heated for six hours at 60° C. under an atmosphere of nitrogen. The silicone oil is evaporated and removed after the end of the reaction to obtain a transparent resin (dispersant A).

### 2) Addition of Reactive Group to Dispersant

Next, 0.5 parts by mass of the dispersant A, 10 parts by mass of titanium oxide (Ishihara Sangyo, CR-90), and 80 parts by mass of a silicone oil are combined in a reaction vessel including an stirrer, a thermometer, and irradiated by ultrasonic waves for one hour using a homogenizer to disperse the titanium oxide. After the irradiation, 0.1 parts by mass of 4-vinylbenzyl chloride is added and heated for three hours at 40° C. to modify the excess amino group of the dispersant adsorbed on the titanium oxide into a vinyl group.

### 3) Formation of White Complex Particles

Next, 30 parts by mass of 2-vinylnaphthalene, 30 parts by mass of a methacryloxypropyl modified silicone (Silaplane FM-0721 manufactured by JNC Corporation), which is a macromer, and 7.5 parts by mass of lauroyl peroxide are added to the above and reacted for ten hours at 65° C. By collecting and drying only the solid components after the end of the reaction, positively charged white titanium oxide-resin complex particles including an amino group are formed.

### Comparative Example 3

Evaluation is performed in a similar manner to Example 1 except that the silicone oil KF-96-2cs is changed to toluene (SP value: 38.26 [(J/cm³)^{1/2}] (≈9.14 [(cal/cm³)^{1/2}]). The result is shown in the following Table 1.

### <Evaluation Test>

### —Measurement of Volume-Average Primary Particle Diameter of Particles—

The volume-average primary particle diameter of the particles is measured using a Coulter Multisizer-II type (manufactured by Beckman Coulter Inc.) with an aperture diameter of 50 μm. At this time, the measurement is performed after the particles are dispersed in an electrolyte aqueous solution (Isoton aqueous solution manufactured by Beckman Coulter Inc.) and dispersed using ultrasonic waves over 30 seconds or longer.

As the measurement method, 0.5 to 50 mg of the measurement sample is added to a surfactant as the dispersant, desirably 2 ml of a 5% aqueous solution of sodium alkylbenzenesufonate, and the mixture added to 100 to 150 ml of the electrolyte solution. The granularity distribution of the particles is measured by performing a dispersion process on the electrolyte solution in which the measurement sample is suspended for one minute using an ultrasonic disperser. The number of particles measured is 50,000.

An accumulated distribution for the volume is drawn from the small diameter end with the measured granularity distribution with respect to separate granularity ranges (channels), and the particle diameter at an accumulation of 50% is defined as the volume-average primary particle diameter.

### —Measurement of Glass Transition Temperature of Resin Included in Particles—

The glass transition temperature is measured in compliance with JIS 7121-1987 using a differential scanning calorimeter (DSC-50 manufactured by Shimadzu Corporation). The melting temperature of a mixture of indium and zinc is used as the temperature correction of the detection unit of the device, and the melting temperature of indium is used as the correction of the calorific value.

The particles are put in an aluminum pan as is, the aluminum pan with the particles and an empty aluminum pan for comparison are set, and measurement is performed at a temperature increase speed of 10° C./min.

The temperature at a crossing point between extended lines of a base line and a rising line in the heat absorption portion of a DSC curve obtained through measuring is taken as the glass transition temperature.

### (Formation of Cyan Particles)

### 1) Formation of Core Particles

### —Formation of Dispersed Phase—

The following components are mixed while being heated to 60° C., and the dispersed phase is prepared so that the ink solid concentration is 15% by mass and the pigment concentration after drying is 50% by mass.

Styrene acrylic polymer X345 (manufactured by Seiko PMC Corporation): 7.2 g

Aqueous dispersion of a cyan pigment PB 15:3 Emacol SF Blue H524F (manufactured by Sanyo Color Works, Ltd., solid content 26% by mass): 18.8 g

Distilled water: 24.1 g

### —Formation of Continuous Phase—

The following components are mixed to form a continuous phase.

Surfactant KF-6028 (manufactured by Shin-Etsu Chemical Co., Ltd.): 3.5 g

Silicone oil KF-96-2cs (manufactured by Shin-Etsu Chemical Co., Ltd.): 346.5 g

### —Formation of Particles—

50 g of the dispersed phase described above and 350 g of the continuous phase described above are mixed and emulsification is performed for 10 minutes at 30° C. with a rotation speed of 10,000 rpm using an internal gear type tabletop disperser ROBOMICS (manufactured by Primix Corporation). As a result, an emulsified liquid with an emulsified liquid droplet diameter of 2 μm is obtained. The emulsified liquid is dried for 18 hours at a bath temperature of 40° C. with a vacuum degree of 20 mbar using a rotary evaporator.

After centrifuging the obtained particle suspended liquid for 15 minutes at 6,000 rpm and removing the supernatant liquid, a cleaning process of redispersing using the silicone oil KF-96-2CS is repeated three times. 6 g of the core particles are thus obtained. As a result of an SEM image analysis, the average particle diameter is 0.6 μm.

### 2) Shell Formation (Coacervation Method)

### Synthesis of Shell Resin

The following components are mixed, and polymerization is performed over six hours at 70° C. in an atmosphere of nitrogen.

Silaplane FM-0721 (manufactured by JNC Corporation): 50 g

Hydroxyethyl methacrylate (manufactured by Sigma-Aldrich Corporation): 32 g

Monomer AMP-10G (manufactured by Shin-Nakamura Chemical Co., Ltd.) including a phenoxy group: 18 g

Monomer Karenz MOI-BP (manufactured by Showa Denko K.K.) including a block isocyanate group: 2 g

Isopropyl alcohol (Kanto Chemical Co., Ltd.): 200 g

Polymerization initiator AIBN (2,2′-azobisisobutyronitrile manufactured by Sigma-Aldrich Corporation): 0.2 g

The product is purified and dried with cyclohexane as a reprecipitated solvent to obtain a shell resin. 2 g of the shell resin is dissolved in 20 g of a t-butanol solvent to prepare a shell resin solution.

—Particle Covering using Shell Resin—

1 g of the core particles is put in a 200 ml eggplant flask, 15 g of the silicon oil KF-96-2cs is added, and the mixture is stirred and dispersed while adding ultrasonic waves. 7.5 g of t-butanol, 22 g of the shell resin solution, and 12.5 g of the silicon oil KF-96-2cs are sequentially added thereto. The input speed is 2 mL/s for all. t-Butanol removal is performed for one hour at a bath temperature of 50° C. with the a vacuum degree of 20 mbar by connecting the eggplant flask to a rotary evaporator.

The mixture is further heated in an oil bath while being stirred. After first heating for one hour at 100° C. and removing the remaining moisture and the remaining t-butanol, heating is then performed for 1.5 hours at 130° C., and the block group of the block isocyanate group is eliminated to perform a cross-linking reaction of the shell material.

After cooling, after separating the obtained particle-suspended liquid through centrifugation for 15 minutes at 6,000 rpm and removing the supernatant liquid, a cleaning process of redispersing using the silicone oil KF-96-2CS is repeated three times. 0.6 g of cyan phoretic particles is thus obtained.

### (Formation of Red Particles)

### —Preparation of Dispersion Liquid A-1A—

The following components are mixed and ball mill crushing is performed for 20 hours using a 10 mm0 zirconium ball to prepare a dispersion liquid A-1A.

Methyl methacrylate (manufactured by Sigma-Aldrich Corporation): 53 parts by mass

2-(Diethylamino)ethyl methacrylate (manufactured by Sigma-Aldrich Corporation): 0.3 parts by mass

Red pigment RED3090 (manufactured by Sanyo Color Works, Ltd.): 1.5 parts by mass

### —Preparation of Dispersion Liquid A-1B—

The following components are mixed and crushed using a ball mill using the method described for the dispersion liquid A-1A described above to prepare a calcium carbonate dispersion liquid A-1B.

Calcium carbonate: 40 parts by mass

Water: 60 parts by mass

### —Preparation of Dispersion Liquid A-1C—

The following components are mixed, degassing is performed for 10 minutes using an ultrasound machine, and the mixture is stirred using an emulsifier to prepare a mixed liquid A-1C.

Calcium carbonate dispersion liquid A-1B: 4 g

20% salt solution: 60 g

### —Formation of Colored Particles—

After mixing the following components, degassing is performed for 10 minutes using an ultrasound machine.

Dispersion liquid A-1A: 20 g

Ethylene glycol dimethacrylate: 0.6 g

Polymerization initiator V601 (Dimethyl 2,2′-azobis(2-methylpropionate): manufactured by Wako Pure Chemical Industries, Ltd.): 0.2 g.

The mixture is added to the mixed liquid A-1C, and emulsification is performed using an emulsifier. Next, the emulsified liquid is put in a flask, decompression degassing is sufficiently performed, and the flask is enclosed with nitrogen gas. Next, the mixture is reacted for 15 hours at 65° C. to form particles. After cooling, the particles are filtered, the obtained particle powder is dispersed in ion-exchanged water, and calcium carbonate is dispersed in aqueous hydrochloric acid to perform filtration. The particles are prepared by cleaning using sufficiently distilled water and distilled through a nylon sieve with openings of 15 μm and 10 μm. The obtained particles have a volume-average primary particle diameter of 13 μm.

### —Quaternary Ammonium Process—

The obtained particles are dispersed in the silicone oil KF96-1cs (manufactured by Shin-Etsu Chemical Co., Ltd.), the same molar amount of dodecyl bromide (quaternization agent) as the 2-(dimethylamino)ethyl methacrylate used in the formation of the particles is added, and the mixture is heated for six hours at 90° C.

After cooling, the dispersion liquid is washed using a large amount of silicone oil and decompression dried to obtain red phoretic particles. The glass transition temperature of the resin included in the phoretic particles is 145° C.

### (Preparation of Cyan, Red, and White Mixed Liquid)

The cyan phoretic particles (C particles) and the red phoretic particles (R particles) described above, and the white floating particles (floating particles obtained in the examples and comparative examples described above are weighed and mixed so that the solid content is 0.1 g for the C particles, 1.3 g for the R particles, and 2.0 g for the floating particles, the silicone oil KF-96L-2cs (manufactured by Shin-Etsu Chemical Co., Ltd.) is added so that the liquid amount becomes 10 g, and the mixture is ultrasonically stirred to obtain a dispersion liquid for display.

### (Formation of Surface Layer and Evaluation Cell)

### —Synthesis of Polymer Compound A—

The following components are polymerized over six hours at 70° C. in an atmosphere of nitrogen.

Silaplane FM-0721 (manufactured by JNC Corporation, weight-average molecular weight Mw=5000): 5 g

Phenoxyethylene glycol acrylate NK ester AMP-10G (manufactured by Shin-Nakamura Chemical Co., Ltd.): 5 g

Hydroxyethyl methacrylate (manufactured by Wako Pure Chemical Industries, Ltd.): 90 g

Isopropyl alcohol (IPA): 300 g

AIBN (2,2′-azobisisobutyronitrile): 1 g

The obtained product is purified and dried with hexane as a reprecipitation solvent to obtain a polymer compound A.

### —Fabrication of Display Medium Cell for Evaluation—

The polymer compound A described above is dissolved in IPA (isopropyl alcohol) so that the solid concentration is 4% by mass. A solution of the polymer compound A is spin coated on a glass substrate on which ITO (Indium Tin Oxide) as an electrode with a thickness of 50 nm is formed through a sputtering method and dried for one hour at 130° C. to form a surface layer with a film thickness of 100 nm.

Two ITO substrates with a surface layer formed in such a manner are prepared as the surface substrate and the reverse substrate. With a Teflon (registered trademark) sheet with a thickness of 50 μm as a spacer, the surface layer of each is made to be opposing to the display substrate overlapping on the reverse substrate and fixed by clips. The dispersion liquid for display is injected into an empty evaluation cell fabricated in such a manner and used as an evaluation cell.

### (Evaluation of Charge Amount)

A potential difference of 15 V is applied for five seconds between the electrodes so that the surface electrode becomes negative using the fabricated evaluation cell. The dispersed positively charged cyan phoretic particles and the positively charged red phoretic particles move to the negative side electrode, that is, the surface electrode side, and when observed from the display substrate side, black is observed.

When a potential difference of 15 V is then applied for five seconds between the electrodes so that the surface electrode becomes positive, the positively charge cyan phoretic particles and the positively charged red phoretic particles move to the negative side electrode, that is, to the reverse electrode side, and when observed from the display substrate side, white is observed.

Here, the charge amount flowing when a black display changes to a white display is measured using an ammeter (6514 type electrometer manufactured by Keithley Instruments Inc.). The charge amount immediately after the voltage application is subtracted from the charge amount after the end of all particle phoresis to calculate the charge amount. (Precipitation Evaluation of Floating Particles)

The dispersion stability of the floating particle dispersion liquids obtained in the examples and comparative examples described above is evaluated. The dispersion stability is evaluated using the following evaluation standards with the naked eye after placing the floating particle dispersion liquid in a 50 ml conical tube using a centrifuge (centrifuge LC-200 manufactured by Tomy Seiko Co., Ltd.) and performing centrifugation at 4000 rpm/30 minutes. The results are shown in the following Table 1.
A: no change observed.
B: floating particles precipitate, and there are transparent regions within a range of up to one third from the liquid surface.
C: floating particles precipitate, and there are transparent regions within a range beyond one third up to two thirds from the liquid surface.

TABLE 1

| | Core | Shell | | | | Evaluation | |
|---|---|---|---|---|---|---|---|
| | (Verification of hydrophilicity) | (Verification of hydrophobia) | Difference in SP value | | Coverage | Charge amount | |
| | Solubility of resin in water | Solubility of resin in water | [(J/cm³)^{1/2}] | [(cal/cm³)^{1/2}] | ratio | [nC/cm²] | Precipitation |
| Example 1 | 100% | Undetectable | 11.55 | 2.76 | 100% | 4.5 | A |
| Example 2 | 100% | Undetectable | 12.81 | 3.06 | 100% | 5.5 | A |
| Example 3 | 100% | Undetectable | 11.55 | 2.76 | 100% | 6.1 | A |
| Example 4 | 100% | Undetectable | 8.79 | 2.1 | 100% | 6.6 | A |
| Example 5 | 100% | Undetectable | 7.95 | 1.9 | 100% | 19 | B |
| Comparative | 100% | (none) | | | | 55 | C |
| Example 1 | | | | | | | |
| Comparative | Undetectable | (none) | | | | 14 | C |
| Example 2 | | | | | | | |
| Comparative | 100% | Undetectable | 3.85 | 0.92 | | 47 | C |
| Example 3 | | | | | | | |

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. A dispersion liquid for display comprising:
a dispersion medium; and
floating particles which are dispersed and float in the dispersion medium,
wherein the floating particles containing:
core particles including a colorant and a hydrophilic resin; and
a shell covering a surface of each of the core particles and containing a hydrophobic resin with a difference in a solubility parameter of 7.95 (J/cm³)^{1/2} or more, the solubility parameter which is represented as SP value with respect to the dispersion medium.

2. The dispersion liquid for display according to claim 1,
wherein the difference in the solubility parameter is 8.37 (J/cm³)^{1/2} or more.

3. The dispersion liquid for display according to claim 1,
wherein the hydrophobic resin is a polymer derived from a monomer including a vinyl group and a benzene ring.

4. The dispersion liquid for display according to claim 1,
wherein the hydrophobic resin contains at least one selected from the group consisting of styrene, vinyl naphthalene, and vinyl biphenyl.

5. The dispersion liquid for display according to claim 1,
wherein the hydrophobic resin is a copolymer of styrene, methacrylic acid, and dimethyl silicone monomer.

6. The dispersion liquid for display according to claim 5,
wherein the styrene is contained in an amount of 50% by mole to 99.5% by mole with respect to a total amount of the hydrophobic resin.

7. A display medium comprising:
a pair of substrates with at least one of the substrates being light-transmissive; and
the dispersion liquid for display according to claim 1 further including phoretic particles migrating according to a voltage applied between the substrates,
wherein the dispersion liquid is sealed between the pair of substrates.

8. A display device comprising:
the display medium according to claim 7; and
a voltage applying unit capable of applying a voltage between the pair of substrates of the display medium.
